(19) United States
(12) Patent Application Publication
(10) Pub. No.: US 2008/0213450 A1
(43) Pub. Date: Sep. 4, 2008

(54) Antimicrobials Useful for Beverages

(75) Inventors: Barry Edward Carter Williams, Dixon, IL (US); Lisa Ann Hayes, Ashton, IL (US); John Francis Tramontana, Naples, FL (US)

Correspondence Address: WELSH & KATZ, LTD, 120 S RIVERSIDE PLAZA, 22ND FLOOR, CHICAGO, IL, 60606, US

(73) Assignee: F.B.C. Industries, Inc.

(21) Appl. No.: 12/038,714

(22) Filed: Feb. 27, 2008

Related U.S. Application Data
(60) Provisional application No. 60/904,722, filed on Mar. 2, 2007.
(60) Provisional application No. 60/918,818, filed on Mar. 19, 2007.

(51) Int. Cl. A23L 2/44; A23L 3/3454

(52) U.S. Cl. 426/532

(57) ABSTRACT

A method for reducing the growth of organisms in beverages and food items intended for mammalian consumption utilizes food grade antimicrobials of a blend of an aqueous solution of sodium benzoate and an aqueous solution of potassium sorbate that can be added to beverages and food items which have a light taste or fragrance and to which antimicrobials with a strong taste or odor are not acceptable.

This application claims the benefit of U.S. Provisional Applications Nos. 60/904,722, filed Mar. 2, 2007, and 60/918,818, filed Mar. 19, 2007, both of which are incorporated herein by reference.

### BACKGROUND OF THE INVENTION

1. Field of the Invention

The present invention relates to improved antimicrobials useful in reducing the growth of organisms in beverages and food items intended for mammalian consumption, and more particularly to food grade antimicrobials that can be added to beverages and food items which have a light taste or fragrance and to which antimicrobials with a strong taste or odor are not acceptable.

2. Description of Related Art

The beverage industry uses sodium benzoate as its primary antimicrobial agent. A primary concern of the beverage industry is Saccharomyces cerevisiae and Zygosaccharomyces bailii, both of which are yeast organisms which vigorously convert glucose to carbon dioxide and can produce pressures up to eighty PSIG. Both sodium benzoate and potassium sorbate have characteristic odors and taste which adversely affect the acceptance of beverages containing these compounds.

Thus, it would be advantageous to provide compositions and methods which are effective in reducing the growth of yeast organisms such as those described above, and which do not adversely affect the taste and odor of substances, such as beverages or food items.

### SUMMARY OF THE INVENTION

We have determined that a blend of an aqueous solution of sodium benzoate and an aqueous solution of potassium sorbate is effective in reducing the growth of yeast organisms and particularly Saccharomyces cerevisiae and Zygosaccharomyces bailii. While an effective antimicrobial composition can be prepared by mixing dry sodium benzoate and dry potassium sorbate with water to obtain an aqueous product, the product has a taste and odor which is useful as an antimicrobial, but is generally not acceptable in a beverage, particularly in a beverage which does not have a strong taste and/or odor which masks the taste and/or odor of the sodium benzoate and potassium sorbate ingredients. It has been unexpectedly found that a blend of aqueous solutions of sodium benzoate and potassium sorbate appears to have a synergistic effect which allows for lower usage rates of the blend as compared to use of sodium benzoate alone while minimizing off-flavor, disagreeable odors, and unacceptable characteristics overall in beverages.

### DETAILED DESCRIPTION OF THE INVENTION

It is preferable in accordance with this invention to utilize an aqueous blend of an aqueous solution of potassium sorbate and an aqueous solution of sodium benzoate that is generally recognized as safe (GRAS) for use in beverages for mammalian consumption, particularly for human consumption as an antimicrobial in beverages to reduce the growth of yeast organisms such as those described above.

One embodiment of the invention is to utilize aqueous solutions of sodium benzoate and potassium sorbate at levels which, when blended, has a taste and odor acceptable in the beverage in which the blend is to be utilized.

Another embodiment is to utilize aqueous solutions of each of sodium benzoate and potassium sorbate which are blended, for example by mixing to achieve a homogenous antimicrobial product. In this embodiment it is preferable to blend by mixing aqueous solutions of sodium benzoate and potassium sorbate which are FCC (Food Chemicals Codex) grade liquids and which are GRAS. Most preferably, in accordance with this invention, is the use of a blend of FCC grade aqueous sodium benzoate containing approximately 33% solids by weight and FCC grade aqueous potassium sorbate containing approximately 50% solids by weight, available from FBC Industries, Inc., Schaumburg, Ill. U.S.A. The two aqueous solutions are desirably present in ratios of from about 1:1 to about 1:5 sodium benzoate to potassium sorbate based on the weight of the solids of each ingredient and in aqueous solution of from about 40% to about 45% total solids by weight.

Most preferably the FCC grade liquid aqueous solutions of sodium benzoate and potassium sorbate are present in a ratio of from about 1:1 to about 1:1.3 based on solids by weight. Particular preferred weight FCC grade liquid solutions ratios of sodium benzoate to potassium sorbate obtained from FBC Industries, Inc. as noted above are 1:1 in a 40% solids aqueous solution, 1:1.1515 in a 41.5% solid aqueous and 1:1.3 in a 44% solids aqueous solution. These particular ratios and solids content of the aqueous solutions described above obtained from FBC Industries, Inc. were found to be effective as antimicrobial agents and effectively encompass a broader pH range than the individual ingredient solutions and have improved odor and taste in beverages. It is believed that the above particular preferred antimicrobial solutions have a synergistic effect on the aforementioned yeast organisms as compared to solutions of either sodium benzoate or potassium sorbate alone.

These and other embodiments and advantages of the invention will be apparent to those skilled in the art from the above description and the appended claims.

What is claimed is:

1. A method of reducing the growth of organisms in substances intended for mammalian consumption, comprising:
a. preparing a blend of an aqueous solution of sodium benzoate and an aqueous solution of potassium sorbate, and;
b. adding the blend to the substance in which the growth of organisms is to be reduced.

2. The method of claim 1, wherein the substance is a beverage intended for human consumption.

3. The method of claim 2, wherein the aqueous solutions of sodium benzoate and potassium sorbate are Food Chemicals Codex grade liquids and are of a grade generally recognized as safe for use in beverages for human consumption.

4. The method of claim 3, wherein the sodium benzoate and potassium sorbate are present at levels which when blended, have a taste and odor acceptable in the beverage in which the blend is utilized.

5. The method of claim 4, wherein the aqueous solution of sodium benzoate and the aqueous solution of potassium sorbate are blended.

6. The method of claim 5, wherein the aqueous solution of potassium sorbate and the aqueous solution of sodium benzoate are present in an approximately 1.0 to 1.5 ratio by weight of solids of the sodium benzoate to potassium sorbate and in an aqueous solution of from about 40% to about 45% total solids by weight.

7. The method of claim 5, wherein the aqueous solution of potassium sorbate and the aqueous solution of sodium benzoate are present in an approximately 1.0 to 1.3 ratio by weight of solids of the sodium benzoate to potassium sorbate and in an aqueous solution of from about 40% to about 45% total solids by weight.

8. The method of claim 5, wherein the aqueous solution of potassium sorbate and the aqueous solution of sodium benzoate is in a ratio of sodium benzoate to potassium sorbate of approximately 1 to 1 by weight of solids and in an aqueous solution of about 40% total solids by weight.

9. The method of claim 5, wherein the aqueous solution of potassium sorbate and the aqueous solution of sodium benzoate is in a ratio of sodium benzoate to potassium sorbate of approximately 1.0 to 1.15 by weight of solids and in an aqueous solution of about 41.5% total solids by weight.

10. The composition of claim 5, wherein the aqueous solution of potassium sorbate and the aqueous solution of sodium benzoate is in a ratio of sodium benzoate to potassium sorbate of approximately 1.0 to 1.3 by weight of solids and in an aqueous solution of about 44% total solids by weight.
